(19) United States
(12) Patent Application Publication
(10) Pub. No.: US 2002/0106145 A1
(43) Pub. Date: Aug. 8, 2002

(54) Optical switch

(75) Inventors: Sang Shin Lee, Kyonggi-do (KR); Jae Yeong Park, Seoul (KR); Jong Uk Bu, Kyonggi-do (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/066,764

(22) Filed: Feb. 6, 2002

(30) Foreign Application Priority Data
Feb. 7, 2001 (KR) 2001-5983

(51) Int. Cl. G02B 6/35

(52) U.S. Cl. 385/18

(57) ABSTRACT

The present invention relates to an N×N OXC (optical cross-connect) optical switch of micro-mirrors, wherein an input optical fiber bundle is fitted to a first substrate of silicon or glass, and an output optical fiber is fitted to the first substrate at a distance from the input optical fiber bundle, to face each other. There are an input micro-mirror and an output micro-mirror part between the optical fiber input part and the optical fiber output part, at a distance from the input micro-mirror part to face each other, and at 45° to a direction of an optical path of a light from the input optical fiber bundle. For fixing them, the present invention employs a method, in which grooves are formed in the first substrate, in which the third substrates of the input/output micro-mirrors and the second substrates of the input/output optical fiber bundles are inserted. The present invention having the foregoing system shortens a total optical path significantly, thereby, not only reducing a total optical loss, but also enhancing a reliability, to provide large capacity, low cost optical switches.

### BACKGROUND OF THE INVENTION

1. Field of the Invention

The present invention relates to an optical switch, and more particularly, to N×N OXC (optical cross-connect) optical switch of micro-mirrors.

2. Background of the Related Art

Since middle of 1990s, as the Internet, e-trade, and the like are spread, there has been a tremendous increase of communication information volume. For the most effective and economic transmission of the large volume of information, there have been researches on a dense wavelength division multiplexing optical communication system, resulting to install an initial form of the system at site, recently. The system requires exchange of many optical signals, which is done by converting an optical signal into an electric signal, transmitting the electric signal electrically, and converting the electric signal to an optical signal again, currently. However, as a system capacity increases, an OXC switch for all-optical switching without optical-electrical-optical conversion. FIG. 1 illustrates a related art OXC switch.

Referring to FIG. 1, the related art OXC switch is formed of an optical fiber bundle having a two dimensional array of optical fiber for input/output of light, and together with this, for switching optical paths, comparatively large scale of reflectors, and micro-mirrors are employed.

Referring to FIG. 2, the micro-mirror is supported on a post, and has to rotation axes. A light from an optical fiber at an input terminal is reflected at the reflector, and the micro-mirror, to be switched to an optical fiber at an output terminal. A total path length from the input terminal to the output terminal is approx. 4L, where ‘L’ denotes a distance between the optical fiber and the micro mirror; for an approx. 100×100 optical switch, in general, ‘L’ is approx. 100 mm. Thus, since the total length of the optical path is very long, there has been much light loss caused by beam divergence even if optical fiber collimators are used. Moreover, device packaging is not only difficult, but also requires much time, and has a poor reliability, because the optical fiber bundle and micro-mirrors are required to be assembled in a space for making a precise light alignment.

### SUMMARY OF THE INVENTION

Accordingly, the present invention is directed to an optical switch that substantially obviates one or more of the problems due to limitations and disadvantages of the related art.

An object of the present invention is to provide a large capacity optical switch which has a small optical loss, and can be packaged easily.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the optical switch includes a substrate, an optical fiber input part in a predetermined region of the substrate, an optical fiber output part in a predetermined region of the substrate at a distance from the optical fiber input part to face each other, a first micro-mirror part between the optical fiber input part and the optical fiber output part, for reflecting a light from the optical fiber input part, and a second micro-mirror part between the optical fiber input part and the optical fiber output part, at a distance from the first micro-mirror part to face each other for reflecting the light from the first micro-mirror part to the optical fiber output part.

The substrate has grooves of predetermined depths in the regions of the optical fiber input/output parts, and the first, and second micro-mirror parts for fixing the optical fiber input/output parts, and the first, and second micro-mirror parts thereto, wherein the groove has upper sloped sides, and lower vertical sides, to form a ‘Y’.

The first, and second micro-mirror parts are arranged to be at 45° to an optical path of the light from the optical fiber input part.

Or alternatively, the optical switch of the present invention may be fabricated by disposing optical fiber input/output parts parallel to each other on predetermined regions of a substrate, placing a first micro mirror part at a distance from the optical fiber input part on a predetermined region of the substrate for reflecting the light from the optical fiber input part, and placing a second micro mirror part at a distance from the first micro mirror part to face each other on a predetermined region of the substrate for reflecting the light from the first micro mirror part to the optical fiber output part.

The optical fiber input part includes a silicon substrate, and a two dimensional array of a plurality of input optical fibers fitted to the substrate, and the optical fiber output part includes a silicon substrate, and a two dimensional array of a plurality of output optical fibers fitted to the substrate at a distance from the input optical fibers.

The optical switch of the present invention, not only can reduce an overall optical loss by shortening an overall optical path significantly, but also can provide a large capacity optical switch having a high reliability, and a low cost.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a related art OXC switch;

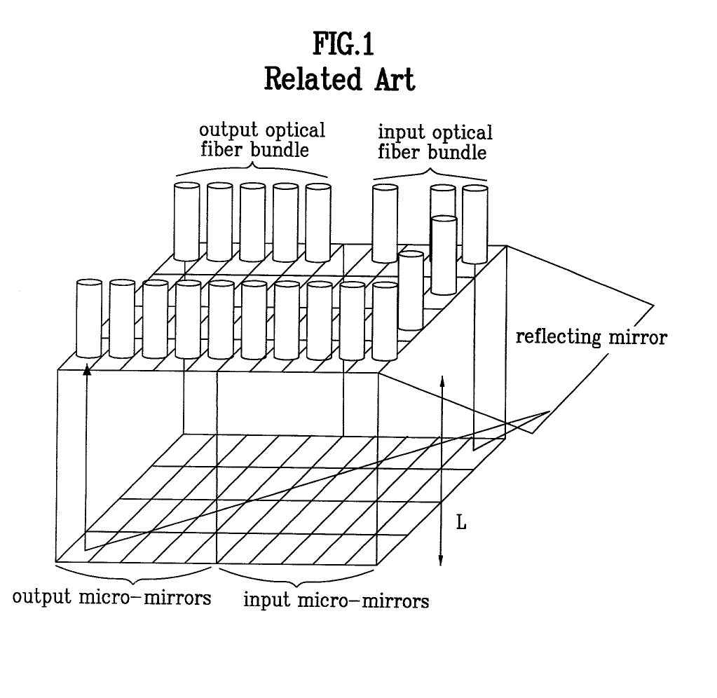

FIG. 2 illustrates a micro-mirror in FIG. 1;

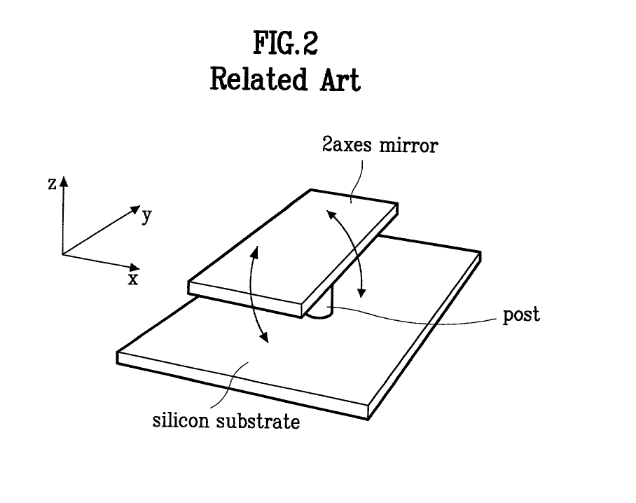

FIG. 3 illustrates a perspective view of an OXC optical switch in accordance with a first preferred embodiment of the present invention;

FIG. 4 illustrates a plan view of FIG. 3;

FIGS. 5A-5C illustrate sections showing the steps of a method for forming a groove in the first substrate in FIG. 3;

FIG. 6 illustrates a section of third substrates of micro-mirrors inserted in grooves in a first substrate; and,

FIG. 7 illustrates a plan view of an OXC optical switch in accordance with a second preferred embodiment of the present invention.

### DETAILED DESCRIPTION OF THE PREFERRED EMBODIMENT

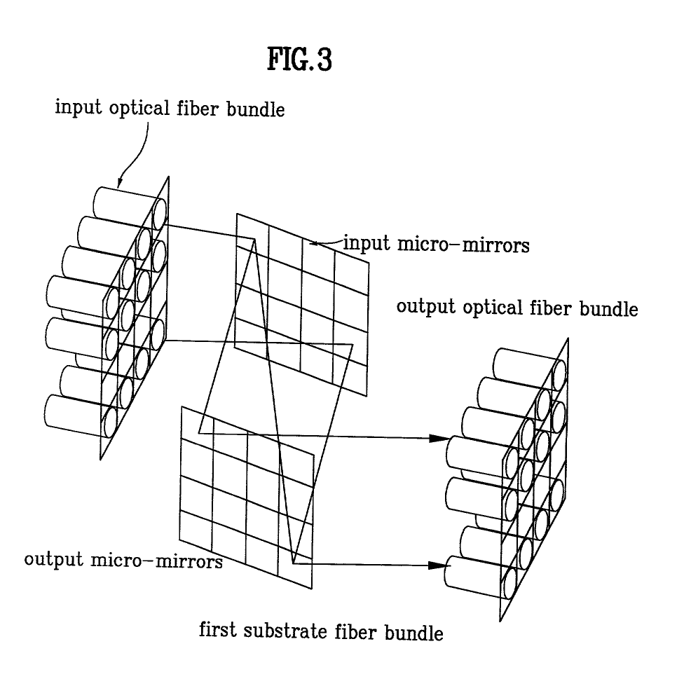

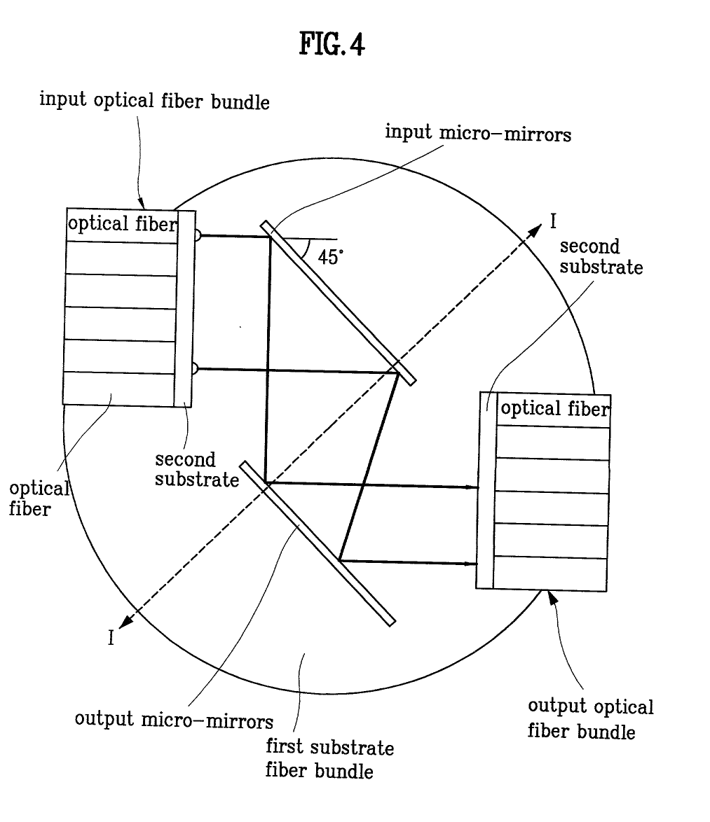

Reference will now be made in detail to the preferred embodiments of the present invention, examples of which are illustrated in the accompanying drawings. FIG. 3 illustrates a perspective view of an OXC optical switch in accordance with a first preferred embodiment of the present invention, and FIG. 4 illustrates a plan view of FIG. 3.

Referring to FIGS. 3-4, there are an input optical fiber bundle placed on a first substrate of silicon or glass, and an output optical fiber bundle placed on the first substrate at a location spaced a distance from the input optical fiber bundle. Each of the input/output optical fiber bundles is a two dimensional array of a plurality of optical fibers fitted on a second substrate of silicon. There are an input micro-mirror, and an output micro-mirror placed between the input optical fiber bundle and the output optical fiber bundle to face each other at a distance, and at a 45° to a direction of light from respective optical fiber bundles. Each of the input/output micro-mirrors is a two dimensional array of a plurality of micro-mirrors each having two rotational axes fitted to a third substrate.

It is required that the input/output micro-mirrors, and the input/output optical fiber bundles are fixed to the first substrate, accurately. Therefore, the present invention suggests to insert, and fix the third substrate of the input/output micro-mirrors, and the second substrate of the input/output optical fiber bundles in respective grooves formed in the first substrate, to facilitate an optical alignment between the input/output micro-mirrors and the input/output optical fiber bundles, not by an active method, but by a self-alignment method.

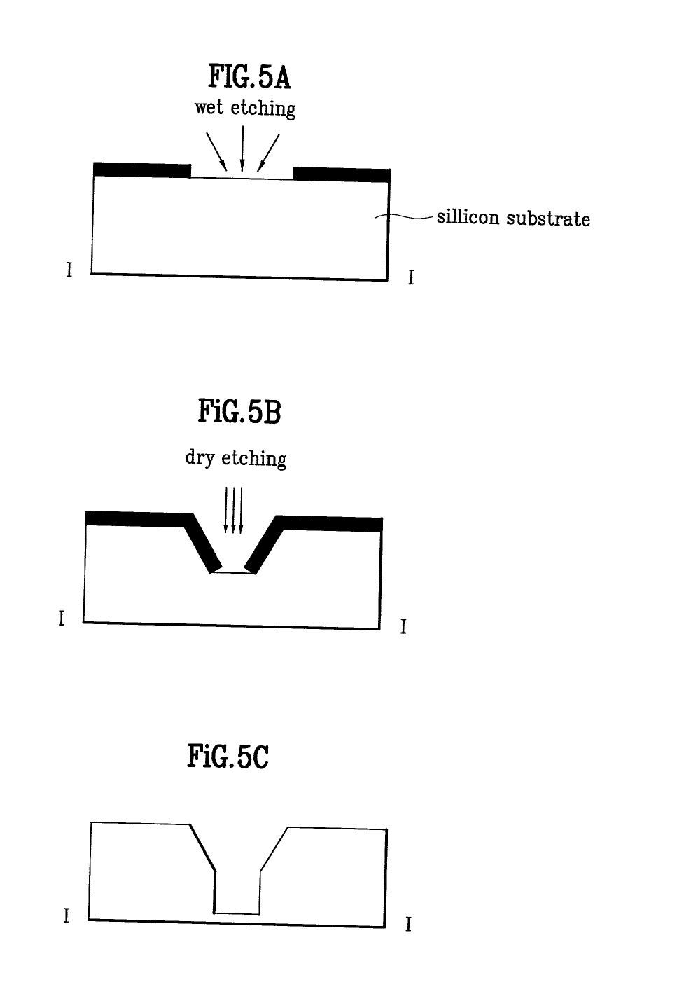

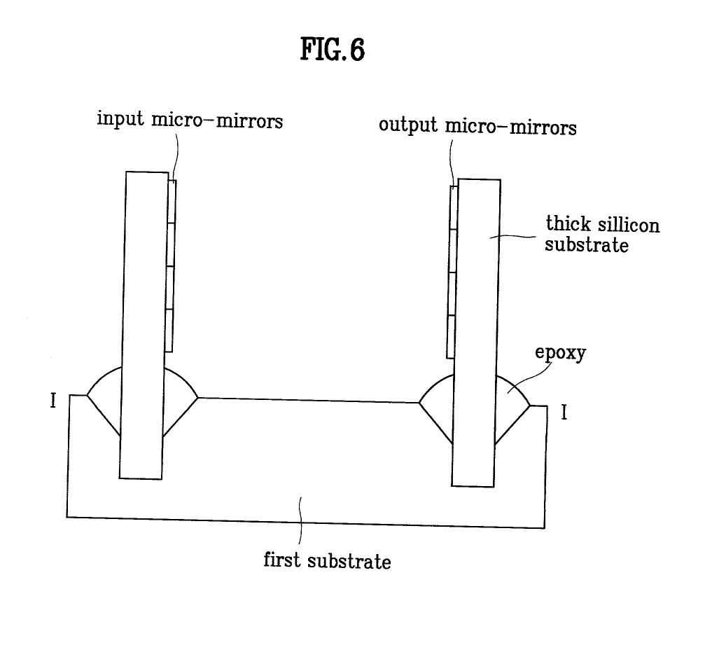

The optical alignment will be explained in more detail. FIGS. 5A-5C illustrate sections showing the steps of a method for forming a groove in the first substrate in FIG. 3, and FIG. 6 illustrates a section of third substrates of micro-mirrors inserted in grooves in a first substrate.

Referring to FIG. 5A, a groove is patterned on a first substrate of silicon, and wet etched, to form a sloped groove.

Then, referring to FIG. 5B, the first substrate with a sloped groove is subjected to dry etching by using deep RIE, to form a vertical groove in the sloped groove, to form a Y formed groove having sloped upper part sides, and vertical lower part sides as shown in FIG. 5C. Because the third substrates of the input/output micro-mirrors and the second substrates of the input/output optical fiber bundles are required to be inserted in the first substrate in vertical, it is required that a perpendicularity of the dry etching process is controlled accurately.

Referring to FIG. 6, the third substrates of the input/output micro-mirrors, and the second substrates (not shown) of the input/output optical fiber bundles are respectively inserted in the grooves in the first substrate, vertically. In this instance, the sloped part at the entrance of the groove facilitates an easy initial insertion of the third substrates of the input/output micro-mirrors, and the second substrates of the input/output optical fiber bundles, and the vertical part of the groove at an inside of the groove facilitates vertical insertion, and fixation of the third substrates of the input/output micro-mirrors and the second substrates of the input/output optical fiber bundles are required to be inserted in the first substrate. Thus, since initial upper and lower sides, and left and right sides alignments between the third substrates of the input/output micro-mirrors and the second substrates of the input/output optical fiber bundles are very important, precise control of widths, lengths, and depths of the grooves is very important.

Then, the third substrates of the input/output micro-mirrors, and the second substrates of the input/output optical fiber bundles inserted in respective grooves in the first substrate are fixed by epoxy, eventually fixing the third substrates of the input/output micro-mirrors, and the second substrates of the input/output optical fiber bundles, not in a free space, but to the first substrate, thereby permitting, not an active optical alignment, but an optical high precision self-alignment.

An optical path of the foregoing optical switch is as follows.

A light from a port of the input optical fiber bundle is incident to the input micro-mirror at 45°, and a rotation angle of a pertinent micro-mirror is controlled in two dimensions finely, to change the optical path to a desired direction. The light having the optical path changed is incident to the output micro mirror, and a rotation angle of a pertinent micro-mirror is controlled in two dimensions finely, to change the optical path again, to direct the light to one port of the output optical fiber bundle, vertically.

As a total optical path from an input terminal to an output terminal is in a range of a distance between the two micro mirrors, not greater than ¼ of the same in the related art, a total light loss can be reduced. Moreover, if the input/output optical fiber bundles are fitted to respective second substrates, but one second substrate, a fabrication process becomes much simpler.

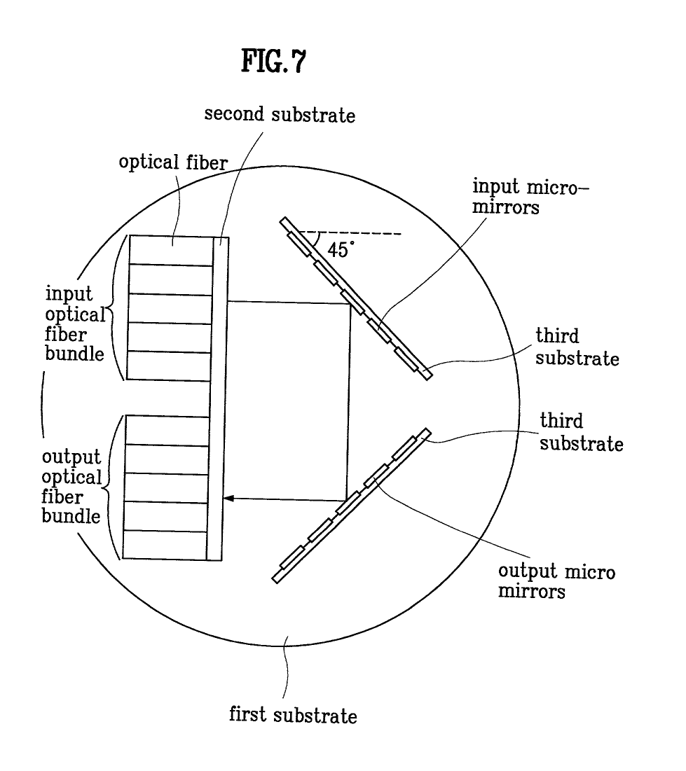

FIG. 7 illustrates a plan view of an OXC optical switch in accordance with a second preferred embodiment of the present invention.

Referring to FIG. 7, the OXC optical switch in accordance with a second preferred embodiment of the present invention includes an input optical fiber bundle, and an output optical fiber bundle fitted in parallel to one second substrate which is in turn fixed in a groove in a first substrate, and, alike the first embodiment of the present invention, input/output micro mirrors fitted to third substrates at a 45° to an optical path from the input optical fiber bundle, which is in turn fixed to grooves in the first substrate.

In the second embodiment of the present invention, since the input/output optical fiber bundles are integrated to one substrate, the optical alignment is simpler and easier than the first embodiment of the present invention in which the input optical fiber bundle, and the output optical fiber bundle are separate.

As has been explained, the optical switch of the present invention is effective for fabrication of low loss, highly reliable, and low cost OXC optical switches, because self-alignment type, high precision optical alignment is easy, and a total optical loss can be reduced.

It will be apparent to those skilled in the art that various modifications and variations can be made in the optical switch of the present invention without departing from the spirit or scope of the invention. Thus, it is intended that the present invention cover the modifications and variations of this invention provided they come within the scope of the appended claims and their equivalents.

What is claimed is:

1. An optical switch comprising:
a substrate;
an optical fiber input part in a predetermined region of the substrate;
an optical fiber output part in a predetermined region of the substrate at a distance from the optical fiber input part to face each other;
a first micro-mirror part between the optical fiber input part and the optical fiber output part, for reflecting a light from the optical fiber input part; and,
a second micro-mirror part between the optical fiber input part and the optical fiber output part, at a distance from the first micro-mirror part to face each other for reflecting the light from the first micro-mirror part to the optical fiber output part.

2. An optical switch as claimed in claim 1, wherein the substrate has grooves of predetermined depths in the regions of the optical fiber input/output parts, and the first, and second micro-mirror parts for fixing the optical fiber input/output parts, and the first, and second micro-mirror parts thereto.

3. An optical switch as claimed in claim 2, wherein the groove has upper sloped sides, and lower vertical sides, to form a ‘Y’.

4. An optical switch as claimed in claim 2, wherein the groove has epoxy applied thereto, for fixing the optical fiber input/output parts, and the first, and second micro-mirror parts, thereto.

5. An optical switch as claimed in claim 2, wherein the first, and second micro-mirror parts are arranged to be at 45° to an optical path of the light from the optical fiber input part.

6. An optical switch as claimed in claim 1, wherein each of the optical fiber input/output parts includes a silicon substrate, and a two dimensional array of a plurality of optical fibers fitted to the substrate, and each of the first, and second micro-mirror parts includes a silicon substrate, and a two dimensional array of a plurality of micro-mirrors fitted to the substrate.

7. An optical switch as claimed in claim 1, wherein the optical fiber input/output parts are fitted parallel to each other as one bundle, to face the first, and second micro-mirror parts at 45°.
